(19) United States
(12) Patent Application Publication
(10) Pub. No.: US 2010/0329206 A1
(43) Pub. Date: Dec. 30, 2010

(54) DUAL IDLE-TRAFFIC STATE OF WIRELESS COMMUNICATION DEVICE

(76) Inventors: Timothy A. Thome, San Diego, CA (US); Amit Kalhan, San Diego, CA (US)

Correspondence Address: KYOCERA INTERNATIONAL INC.;INTELLECTUAL PROPERY DEPARTMENT, P.O. BOX 928289, SAN DIEGO, CA, 92192, US

(21) Appl. No.: 12/495,395

(22) Filed: Jun. 30, 2009

(51) Int. Cl. H04W 36/00

(52) U.S. Cl. 370/331

(57) ABSTRACT

A wireless communication device maintains a dual idle-traffic state where the wireless communication device is in an idle state relative to a first transceiver node and is in a traffic state relative to a second transceiver node. First control signals are received from the first transceiver node and second control signals are received from the second transceiver node where the second control signals are different from the first control signals.

### TECHNICAL FIELD

The invention relates in general to wireless communication systems and, more specifically, to a dual idle-traffic state of wireless communication devices.

### BACKGROUND

Wireless communication networks provide wireless communication services to portable wireless communication devices through a plurality of transceiver nodes that have geographical service coverage areas often referred to as cells. Transceiver nodes may be referred to as base stations, access points, Node B and other terms depending on the particular type of communication system. A transceiver node provides a cell that may have any of several sizes and shapes where a terminology has developed to categorize the various cell sizes. Cells can be categorized as macrocells, microcells, picocells, and femtocells. Macrocells are typically deployed with wireless wide area networks (WWAN) and have sizes measured in miles. Microcells are typically implemented to cover a block. Picocells are generally considered to be smaller than microcells and may be implemented to cover a small number of suites or a portion of a building. Femtocells are the smallest of the four categories and are typically implemented as extensions to other networks to provide service to a single residence or other similar small area.

In some implementations, networks using different communication technologies may provide service within overlapping geographical service areas. Wireless local area networks (WLANs) and wireless wide area networks (WWANs) provide wireless communication services to portable devices where the WLANs typically provide services within geographical service areas that are smaller than the geographical areas serviced by WWANs. Examples of WWANs include systems that operate in accordance with 2.5G (such as cdma2000), 3G (such as UMTS, WiMax), and other types of technologies, where each base station of the WWAN is typically designed to cover a service area having a size measured in miles. The term WWAN is used primarily to distinguish this group of diverse technologies from WLANs that typically have smaller service areas on the order of 100 to 300 feet per base station. Base stations in WLANs are typically referred to as access points. An access point may be connected to the Internet, intranet, or other network through wires or wirelessly through a WWAN. Examples of WLANs include systems using technologies such as Wi-Fi and other wireless protocols in accordance with IEEE 802.11 standards. WLANs typically provide higher bandwidth services than WWANs at the expense of non-ubiquitous coverage whereas WWANs provide increased coverage areas at the cost of bandwidth and/or capacity. In order to provide a wireless user with the increased overall performance and continuous connectivity, multi-mode and dual-mode portable communication devices have been developed allowing the communication device to access the particular type of network that provides the most desirable tradeoffs. A multi-mode wireless communication device includes the appropriate components and functionality for communicating within more than one network. For example, a dual-mode portable communication device can communicate within a WWAN and a WLAN.

In order to provide a wireless user with the increased overall performance and continuous connectivity, a wireless communication device is sometimes handed-off (transferred) from one transceiver node to another. In conventional communication systems, the wireless communication device relinquishes communication and registration from the first transceiver node when handed-off to the new transceiver node.

### SUMMARY

A wireless communication device maintains a dual idle-traffic state where the wireless communication device is in an idle state relative to a first transceiver node and is in a traffic state relative to a second transceiver node. First control signals are received from the first transceiver node and second control signals are received from the second transceiver node where the second control signals are different from the first control signals.

### BRIEF DESCRIPTION OF THE DRAWINGS

FIG. 1 is a block diagram of a communication system having at least two transceiver nodes and a wireless communication device.

FIG. 2 is a block diagram of a communication system where the first transceiver node is a macrocell base station and the second transceiver node is a femtocell base station 204.

FIG. 3 is a state diagram of the operational states of the wireless communication device where the operational states of the wireless communication device include a dual idle-traffic state.

FIG. 4 is a block diagram of an example of a suitable implementation of the femtocell base station where the detected communication signal is an uplink signal transmitted by the wireless communication device to the macrocell base station.

FIG. 5 is a block diagram of a wireless communication device.

FIG. 6 is a flowchart of a method of managing wireless service to a wireless communication device performed at a core network.

FIG. 7 is a flowchart of a method of managing wireless service to a wireless communication device performed at a second transceiver node such as a femtocell base station.

FIG. 8 is a flowchart of a method of managing wireless communication performed at a wireless communication device.

### DETAILED DESCRIPTION

As discussed above, a wireless communication device relinquishes registration from a transceiver node after a handoff in conventional systems. The wireless communication device registers with the new transceiver node and operates in accordance with the control signals transmitted by the new transceiver node and no longer monitors the control signals transmitted by the original transceiver node. As a result, the wireless communication device must re-register with the original transceiver node if service will resume from the original transceiver node. Unfortunately, in some situations connectivity to the new transceiver node unexpectedly deteriorates or is lost. The re-registration to the originating transceiver node results in dropped calls and other undesirable circumstances. Such circumstances may often occur in arrangements where the first transceiver node is a macrocell base station and the second transceiver node is a femtocell base station. Due to small cell size and less reliable connectivity to the core network of a femtocell base station, wireless service from the femtocell base station may deteriorate quickly or be lost unexpectedly. In the embodiments discussed below, a dual idle-traffic state minimizes the undesired consequences in the situations discussed above as well as maximizes performance of the wireless communication device. Since the wireless communication device maintains an idle state relative to the original transceiver node, traffic (data, voice, etc.) communication can be reinstated much more quickly than in conventional systems.

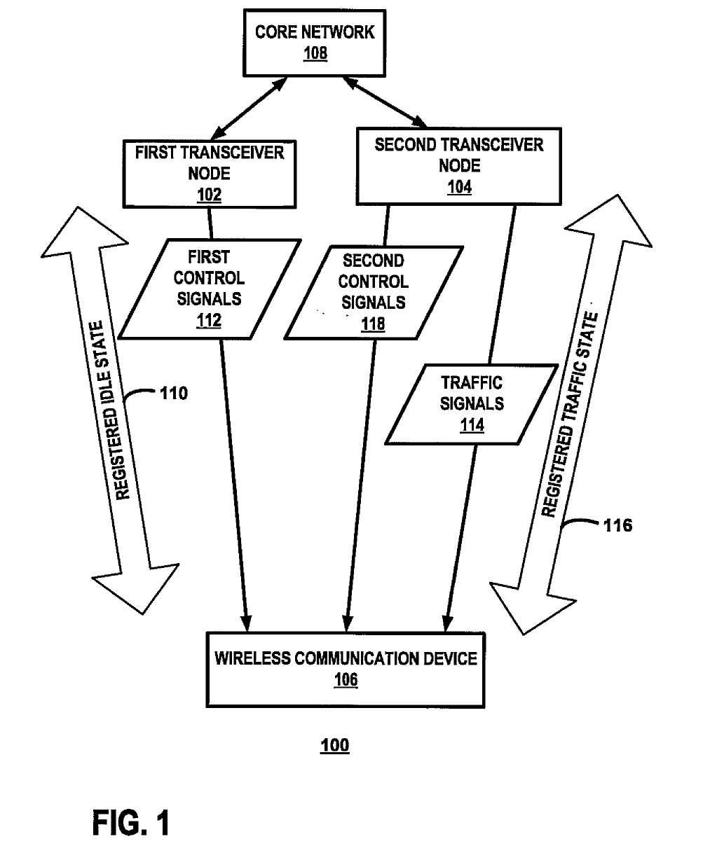

FIG. 1 is a block diagram of a communication system 100 having at least two transceiver nodes 102, 104 and a wireless communication device 106. The communication system 100 may have any of numerous types of wireless communication systems or arrangements of communication systems, networks and infrastructure that operate using any of numerous protocols and standards. Examples of some suitable communication technologies include systems that operate in accordance with Universal Mobile Telecommunications System (UMTS), Code Division Multiple Access (CDMA2000), WiMax, and WiFi techniques. The various components illustrated in FIG. 1 may be referred to by different terms depending on the particular standard or technology. The transceiver nodes 102, 104 may be referred to as base stations, macro base stations, macrocell base stations, picocell base station, microcell base stations, femtocell base stations, access points, Node-Es, cellular base stations and other terms. The wireless communication device 106 may be referred to as a handset, mobile device, access terminal (AT), cell phone, portable device, wireless personal digital assistant (PDA), wireless modem, and by other terms. Where the wireless communication device 106 is capable of communicating on more than one type of network, it may be referred to as dual-mode wireless communication device, tri-mode wireless communication device, multimode wireless device, or other similar names. The core network 108 includes any combination of equipment and infrastructure for communicating with, controlling, and managing the transceiver nodes 102, 104. The core network 108 may be a single network or multiple interconnected networks and can be implemented within a larger communication network (not shown in FIG. 1). For example, the core network may be a single cellular communication network or may include a cellular network interconnected with infrastructure of one or more wireless local area networks (WLANs).

In certain circumstances, the wireless communication device 106 maintains registration 110 with the first transceiver node 102 and receives control signals 112 from the first transceiver node 102 while receiving traffic signals 114 from the second transceiver node 104. In one aspect, the wireless communication device 108 remains in an idle state relative to the first transceiver node 102 and is in a traffic state 116 with the second transceiver node 104. Accordingly, first control signals 112 are received from the first transceiver node 102 and second control signals 118 are received from the second transceiver node 104 at the wireless communication device 108, where the second control signals 118 are different from the first control signals 112. This dual idle-traffic state, where the wireless communication device in idle state relative to the first transceiver node and in traffic state relative to the second transceiver node, allows for efficient system access. One advantage of the idle-traffic state includes the ability for the wireless communication device 106 to reestablish service from the first transceiver node 102 if a handoff to the second transceiver node 104 is unsuccessful or if the connection with the second transceiver node deteriorates unexpectedly. System detection, network reentry and other tasks are not necessary to continue communicating with the first transceiver node 102 since, from the perspective of the first transceiver node 102, the wireless communication device 106 was in the idle state prior to reestablishing traffic communication through the first transceiver node.

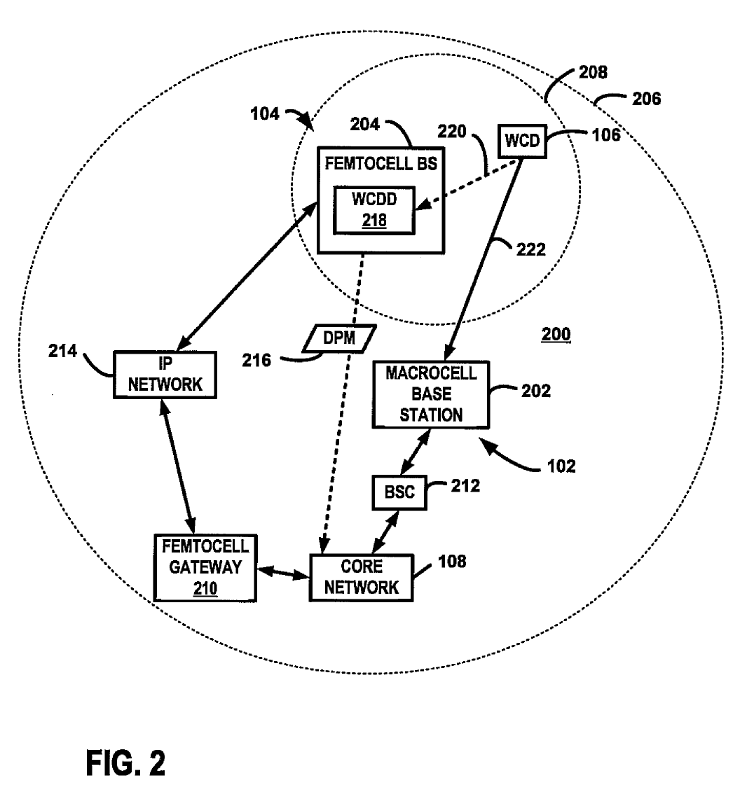

FIG. 2 is a block diagram of a communication system 200 where the first transceiver node 102 is a macrocell base station 202 and the second transceiver node 104 is a femtocell base station 204. Accordingly, the communication system 200 is one example of an implementation of the communication system 100. The communication system 200 operates in accordance with a wireless wide area network (WWAN) technique and protocol such as UMTS, CDMA 2000 or WiMAX techniques. The macrocell base station 202 provides wireless services within a macrocell service area (macrocell) 206 and the femtocell base station 204 provides wireless communication services within a femtocell service area (femtocell) 208. Although the service areas 206, 208 are illustrated with circular dashed-line shapes, the service areas 206, 208 may be any shape or size geographical area. Further, the service areas 206, 208 may contain holes of coverage where service is unavailable. In the interest of clarity and brevity, such features are not illustrated in the figures. The femtocell service area 208 is significantly smaller than the macrocell service area 206 and may be positioned completely within the macrocell service 206, partially overlapping the macrocell service area 206, or may be adjacent to the macrocell service area 206. For the example, the wireless communication device 206 is covered by both service areas 206, 208.

The femtocell base station 204 communicates with the wireless wide area network (WWAN) core network 108 and provides wireless service to one or more wireless communication devices 106. The exemplary communication system 200 discussed with reference to FIG. 2, therefore, operates in accordance with a WWAN standard and at least provides wireless services within macrocells and femtocells. The exemplary communication system 200 operates using packet switching communication techniques. In such systems, the communication infrastructure is a packet switched core network and includes an access gateway 210 for interfacing to the femtocell base station 204 using IP signaling. The exemplary communication system 200, however, may operate in accordance with circuit switched communications in some circumstances. For the examples discussed with reference to FIG. 2, the communication system 200 operates in accordance with UMTS standards and techniques. The communication system 200, however, may operate using any of numerous protocols and schemes. Examples of some Code Division Multiple Access (CDMA) standards include cdma2000 1X, 1×EV-DO, and W-CDMA. In some circumstances, the communication system 200 may operate with other standards such as OFDM based standards or GSM standards, for example. The various functions and operations of the blocks described with reference to the communication system 200 may be implemented in any number of devices, circuits, or elements. Two or more of the functional blocks may be integrated in a single device and the functions described as performed in any single device may be implemented over several devices. For example, at least portions of the functions of the core network 108 may be performed by the femtocell base station 204, macrocell base station 202, a base station controller 212, the femtocell gateway 210, or a mobile switching center (MSC) in some circumstances.

The femtocell base station 204 is a scalable, multi-channel, two-way communication device similar to a typical base station within the particular communication system. The femtocell base station 204, however, is often implemented within a residence, business, or other relatively small area as compared to the macrocell and is connected to the core network through a packet switched network 214 such as an intranet or the Internet. One example of a femtocell base station is a UMTS access point base station containing a Node-B, Radio Network Controller (RNC) and GSN, with an Ethernet or broadband connection to the Internet or an intranet. In some situations, the femtocell base station 204 may be connected to the packet switched network through an ATM/TDM connection. Application of VoIP allows the femtocell base station 204 to provide voice and data services in the same way as a typical base station, but with the deployment simplicity of a Wi-Fi access point. Other examples include CDMA-2000 and WiMAX base stations connected in a similar fashion. The femtocell base stations and the wireless communication devices operate in accordance with the existing radio access network (RAN) technologies.

The femtocell base station 204 provides wireless service to communication devices 106 within adequate range of the femtocell base station 204 within the femtocell 208. Messages sent from the femtocell base station 204 to the core network 108 may be sent using any combination of wired and/or wireless communication methods. In the exemplary embodiment discussed with reference to FIG. 2, the femtocell base station 204 is connected to the access gateway 210 connected to (or in) the core network 108 and sends messages using packet switched data techniques through the IP network. In some circumstances, messages can be sent from the femtocell base station 204 through a PSTN. In other circumstances, a transmitter may be used to wirelessly transmit the messages to the macrocell base station 202 which are then forwarded to the core network 108. The femtocell base station 204, therefore, is connected to, and managed by, the core network 108 through the network interface similarly to other base stations in the systems except that the backhaul to the femtocell base station 204 may include a broadband CATV or DSL connection rather than fiber optic, T1, point-to-point microwave backhaul, or other similar backhauls.

For the example of FIG. 2, the wireless communication device is communicating with the macrocell base station 202 when the femtocell base station 204 detects the presence of the wireless communication device within the femtocell service area 208. A device proximity message (DPM) 216 is sent to the core network 108 in response to the detection and/or a calculation of the proximity of the wireless communication device 106 to the femtocell base station 204. In response to the DPM 216, the core network 108 instructs the wireless communication device 106 to search for the femtocell base station 204. In situations where the femtocell base station refrains from transmitting a pilot signal until necessary, the core network also instructs the femtocell base station 204 to transmit a pilot signal.

A wireless communication device detector 218 in the femtocell base station 204 detects the wireless communication device 106 by receiving a detection signal 220. In this example, the detection signal 220 is an uplink communication signal 222. Accordingly, the femtocell base station 204 detects the wireless communication device 106 by detecting an uplink signal 222 transmitted by the wireless communication device 106 to the macrocell base station 202. Other signals and detection methods may be used. Examples of techniques for detecting the wireless communication device and generating a device proximity message are discussed in U.S. patent application Ser. No. 11/565,266 entitled APPARATUS, SYSTEM AND METHOD FOR MANAGING WIRELESS LOCAL AREA NETWORK SERVICE TO A MULTI-MODE PORTABLE COMMUNICATION DEVICE, docket number TUTL 00104, filed on Nov. 30, 2006; and U.S. patent application Ser. No. 12/037,782, entitled APPARATUS, SYSTEM AND METHOD FOR MANAGING WIRELESS SERVICE TO A WIRELESS COMMUNICATION DEVICE, docket number TUTL 00168, filed on Feb. 26, 2008, both incorporated by reference herein.

For this example, the device proximity message 216 is a request message requesting the execution of an acquisition procedure by the wireless communication device 106 to acquire the femtocell base station 204 while maintaining registration with the macrocell base station 202. In response to the device proximity message 216, the core network 108 sends a message to the communication device 106 instructing the communication device 106 to search for wireless service from an alternate base station or to establish communication with an alternate base station. The instructions may include specific data identifying the femtocell base station 204 as a potential base station for service. Therefore, the device proximity message in the example of FIG. 2 may include a request to establish wireless service from the femtocell base station 204 to the wireless communication device 106. Such an instruction may also comprise control signals for invoking and managing a handoff. The search instruction may also be an update to the neighborhood list that is used for searching for alternative base stations. Accordingly, the search message is any signal or instruction that results in a change in the searching scheme used by the wireless communication device 106 to increase the likelihood of detecting the femtocell base station 204.

In some situations, the core network 108 may evaluate other parameters before instructing the communication device 106. For example, due to subscriber parameters, system settings, or system parameters, the core network 108 may determine that the communication device 106 should not be handed off to another base station. Further, the core network 108 may evaluate parameters corresponding to multiple base stations where device proximity messages identifying a particular communication device 106 are received from more than one femtocell base station 204.

Therefore, the core network 108 may perform an evaluation in response to the device proximity message 216 and may perform or initiate a femtocell acquisition procedure in response to the device proximity message 216. In the example, the device proximity message 216 is sent through the IP network 214 and an access gateway connected to (or within) the core network 108. In some circumstances, however, the device proximity message 216 is sent through a wireless link. For example, the message could be sent as an uplink signal where the femtocell base station 204 includes an uplink transmitter.

When the macrocell base station 202 is providing wireless communication services to the communication device 106, the femtocell base station 204, at least periodically, monitors the uplink channel used by the communication device 106 to transmit uplink signals. In some cases, the femtocell base station 204 may employ procedures to detect multiple communication devices 204. Based on the uplink signal 218 received at the femtocell base station 204, the femtocell base station 204 determines whether the communication device 106 should at least attempt a search for the femtocell base station 204. In some circumstances, the femtocell base station 204 determines that the femtocell base station 204 should provide service to the communication device 106. When the femtocell base station 204 determines that the communication device 106 is within range (or at least possibly with range) of the femtocell base station 204, the femtocell base station 204, transmits the device proximity message 216 to the core network 108 indicating that the communication device 106 is likely within the service area (femtocell 208) of the femtocell base station 204. The core network 108 then performs the service acquisition procedure which may include an instruction for the communication device 106 to search for femtocell base station 204. An example of a situation where the above scenario applies includes the situation where a communication device 106 is approaching the femtocell base station 204 while receiving communication services from macrocell base station 202.

During the service acquisition procedure, the wireless communication device 106 searches for the pilot signal transmitted by the femtocell base station 204. After detecting the pilot signal, the wireless communication device registers on the femtocell base station and communicates with the femtocell base station similarly to communication in conventional systems except that the wireless communication device 106 remains registered on the macrocell base station 202. Accordingly, the wireless communication device 106 remains in the idle state relative to the macrocell base station 202 and continues to receive control signals from the macrocell base station 202 while in the traffic state with respect to the femtocell base station 204. As a result, the wireless communication device 106 may receive one set of control signals from the macrocell base station 202 and another set of control signals from the femtocell base station 204.

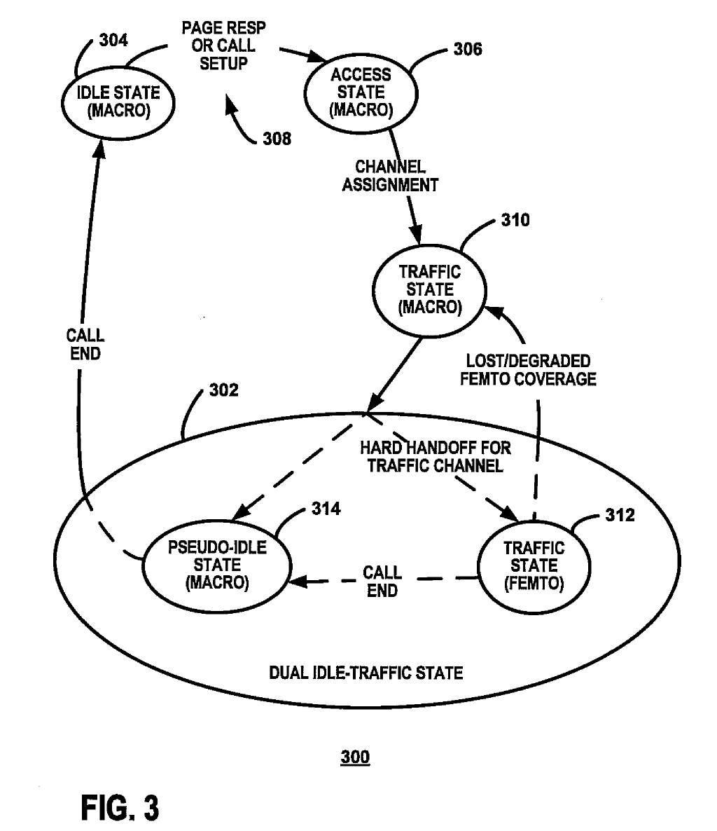

FIG. 3 is a state diagram 300 of the operational states of the wireless communication device 106 where the operational states of the wireless communication device include a dual idle-traffic state 302. The wireless communication device 106 may operate in other states not shown in FIG. 3. The states illustrated show one example of a progression through various states.

In the macrocell idle state 304, the wireless communication device is in an idle state with respect to the macrocell base station. As is known, an idle state is a service condition where data is not transmitted but communication service is immediately available for use. The wireless communication device 106 remains registered on the macrocell base station 202 and monitors one or more control channels such as the paging channel. When data is to be received at or transmitted from wireless communication device, the wireless communication device enters an access state 306. An event 308, such as page response or a call setup, places the wireless communication device into the access state 306. In a typical incoming call scenario, therefore, the wireless communication device 106 monitors the paging channel while in the idle state until a page is received. In response, the wireless communication device 106 enters send a page response message and enters the access state 306.

The macrocell base station 202 assigns traffic channels to place the wireless communication device 106 into the traffic state 308. The wireless communication device 106 can exchange messages, voice and other user data with the macrocell base station 202 in the traffic state 308.

Where a femtocell base station 204 is available to provide service to the wireless communication device 106, the core network 108 may determine that communication should continue through the femtocell base station 204. The wireless communication device 106 enters the dual idle-traffic state 310 in this situation. A hard handoff is performed to place the wireless communication device 106 in a traffic state 312 relative to the femtocell. The wireless communication device 106, however, returns to the idle state 314 with respect to the macrocell base station 202. The pseudo-idle state 312 and the idle state 304 are the same state except that the wireless communication device is also in the traffic state with respect to the femtocell base station 204 when in the pseudo-idle state 312. When the call ends, the wireless communication device returns to the idle state 304.

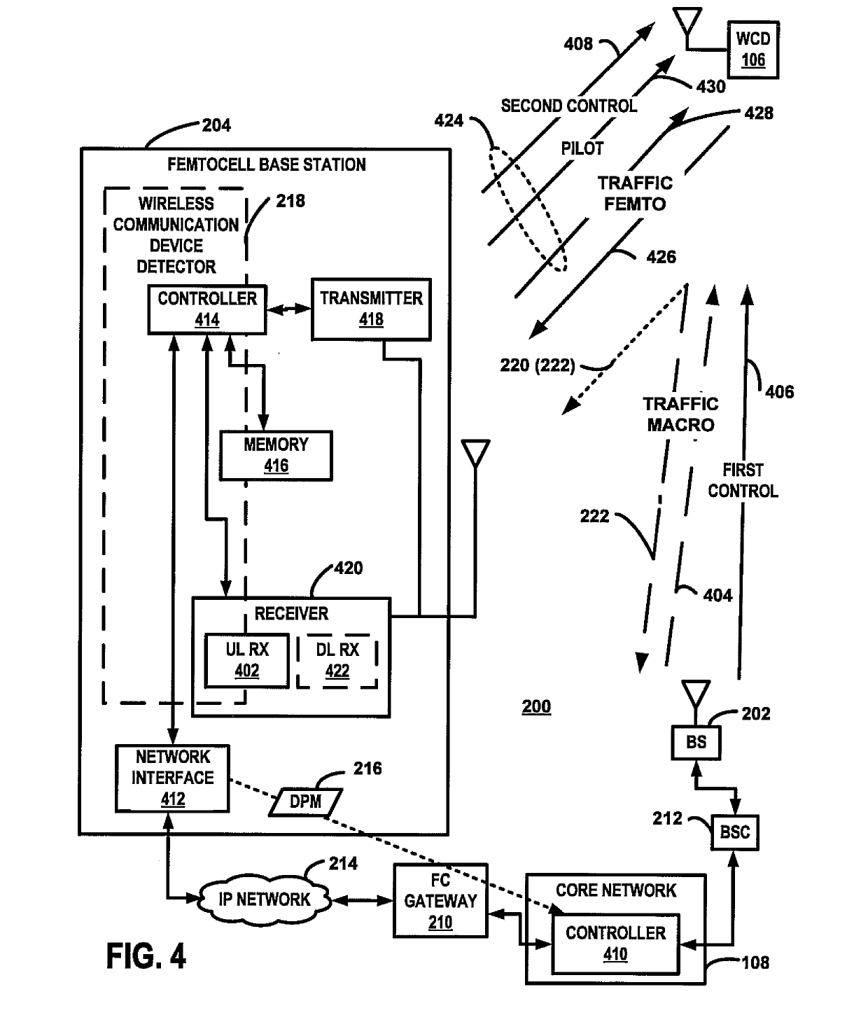

FIG. 4 is a block diagram of an example of a suitable implementation of the femtocell base station 204 where the detected communication signal 220 is an uplink signal 222 transmitted by the wireless communication device 106 to the macrocell base station 202. The various functions and operations of the blocks described with reference to the femtocell base station 204 may be implemented in any number of devices, circuits, or elements. Two or more of the functional blocks may be integrated in a single device and the functions described as performed in any single device may be implemented over several devices.

Accordingly, FIG. 4 is a block diagram of the communication system 200 of FIG. 2 where the wireless communication device detector 218 includes at least a portion of an uplink cellular receiver 402 used for communication. For the example discussed with reference to FIG. 4, the second transceiver node 104 is a femtocell base station 204 that provides wireless service within a femtocell 208 and the first transceiver node is a macrocell base station 202 that provides service within a macrocell 206. The base stations 202, 204 operate in accordance with UMTS protocols and standards. As discussed above, the term macrocell is used primarily to distinguish this group of diverse technologies from picocells and femtocells that typically have smaller service areas on the order of 100 to 300 feet per base station. Accordingly, the macrocell base station 202 is any base station that provides wireless communication services within relatively large geographical areas as compared to the femtocell service area 208 provided by the femtocell base station 204 in the example of FIG. 4. The macrocell base station 202 provides wireless service to one or more wireless communication devices 106 by transmitting downlink signals (forward link signals) 404, 406 to the wireless communication device 106 and receiving uplink signals 222 (reverse link signals) from the wireless communication device 106. The macrocell base station downlink signals include downlink traffic signals 404 and downlink control signals 406. The downlink control signals 406 are referred to as “first control signals” to distinguish these signals from the downlink control signals 408 transmitted from the femtocell base station 204 which are referred to as “second control signals.”

The core network 108 includes a controller 410 that may be implemented as a mobile switching center (MSC), a combination of an MSC and base station controllers (BSCs), or other similar communication controllers. For the example, the BSC 212 is considered as a separate entity to the core network 108 and controller 410. As discussed above, the controller 410 is connected to the femtocell base station 204 through the femtocell gateway 210 and to the macrocell base station 202 through the BSC 212. The controller at least partially manages communications within the system 200. A network interface 412 within the femtocell base station 204 facilitates communication with the IP network 214. The network interface 412, therefore, provides packet data communications and facilitates access to the Internet (or intranet) and to the access gateway 210 through an access router (not shown) or directly through the IP network 214. In some situations, an access router may be implemented within the femtocell base station 204. In some circumstances, the connection between the access gateway 210 and the femtocell base station 204 may include a wireless communication link such as satellite communication link or point-to-point microwave link, for example. Also, in some situations, circuit switched connections may be used to connect the detecting femtocell base station 204 to the core network 108. In a typical arrangement, the femtocell base station 204 is connected to the Internet through an Internet Service Provider (ISP) service provided by a digital subscriber line (DSL) or CATV connection. Accordingly, an access router such as a DSL modem or cable modem provides connectivity in the typical arrangement. In the exemplary embodiment, therefore, the core network 108 facilitates packet switched communications with at least one access gateway 210. The access gateway 210 is a communication interface that allows the femtocell base station 204 to communicate with the core network 108.

In addition to the functions and features discussed herein, the femtocell base station 204 operates in accordance with the communication protocols of the communication system 200. The femtocell base station 204 includes a controller 414, memory 416, transmitter 418, a receiver 420, that includes at least the uplink receiver 402 and may also include a downlink receiver 422, in addition to other devices and software for performing the functions of the femtocell base station 204. The femtocell base station 204 provides wireless service to one or more wireless communication devices 106 by transmitting downlink signals (forward link signals) 424 to the wireless communication device 106 and receiving uplink signals (reverse link signals) 426 from the wireless communication device 106. The downlink signals include the second control signals 408, downlink traffic signals 428 and a pilot signal 430.

The downlink receiver 422 receives downlink signals 404, 406 transmitted by the macrocell base station 202 to the wireless communication device 106. The downlink receiver (DL RX) 422 is illustrated with a doffed box to indicate that it may be omitted in some circumstances. In implementations where the receiver 420 includes the DL RX 422, the femtocell base station 204 intercepts control signals 406 sent to the wireless communication device 106 allowing the controller 414 to retrieve additional information regarding timing, power, level identification values, or other data. In some situations, the DL RX 422 is used to monitor the macrocell base station control channels for synchronization, location determination, scheduling information, system parameters, and/or broadcast services. Further, the DL RX 422 may be used for communication between the macrocell base station and the femtocell base station. For the example, the DL RX 422 acquires the macrocell network signal and, after obtaining all the system parameters and related information, the femtocell base station monitors the network signal periodically. Also, interception of the downlink signals provides accurate timing information enhancing the ability of the femtocell base station to intercept the uplink signals from the wireless communication device. Although the receivers 402, 422 may be implemented as separate receivers, a suitable implementation includes utilizing common hardware and/or software in a cellular receiver 420 to tune and receive the various signals.

For the example in FIG. 4, the wireless communication device detector 218 is implemented by at least a portion of the controller 414, memory 416, and uplink receiver 420. Accordingly, the wireless communication device detector 218 is illustrated with a dashed line box to indicate that the detector 24 may include some or all various functions and devices forming the receiver 420, memory 416, and/or controller 414.

In addition to other information, the memory 416 stores communication device identification values corresponding to each communication device 106 that is authorized to receive service from the femtocell base station 204. The communication device identification value may include an electronic serial number (ESN), Mobile station Equipment Identifier (MEID), or International Mobile Subscriber Identity (IMSI) or other unique data identifying the wireless communication device 106. An example of a group of identification values stored in memory includes a collection of ESNs corresponding to the communication devices of the family members of a household where the femtocell base station 204 provides service. The identification values may be stored at the femtocell base station 204 using any of numerous techniques. An example of a suitable method of storing the values includes storing the values during an initialization procedure performed when the femtocell base station 204 is installed. The identification values may be provided, at least partially, by the core network or macro base station. In some implementations, the identification values may be omitted or the femtocell base station 30 may allow communication devices that do not have corresponding identification values stored at the femtocell base station 204 to receive service from the base station 204.

The ESNs can be used to generate long code masks, such as public long code masks (PLCMs), which allow the femtocell base station to receive signals from the wireless communication device 106 having the particular ESN. Other information may be received from the core network to generate the PLCMs in accordance with known techniques. In some situations, the core network 108, or macrocell base station 202 may assign the PLCM to a particular wireless communication device 106.

During operation, the femtocell base station 204, at least periodically monitors a wireless channel that may include the uplink communication signal 222. For the example of FIG. 4, the femtocell base station 204 monitors the uplink UMTS channel used to transmit signals from wireless communication devices 106 to the macrocell base station 202 (first transceiver node 102). The uplink receiver 402 is tuned to the appropriate channel or channels to detect the uplink signal 222 transmitted by the wireless communication device 106. In the exemplary embodiment, the uplink receiver 402 sufficiently demodulates and decodes uplink signals to identify the long code mask. The long code mask is typically a 42 bit binary number that is unique to the wireless communication device 106. In the example, received signals are compared to a list of long code masks to determine if the signal was transmitted by an authorized wireless communication device 106. As described above, the authorized wireless communication devices are identified by device identifiers stored in memory 416. The identifiers either directly, or indirectly, correspond to long code masks that facilitate reception of the signals transmitted by the authorized devices in the exemplary embodiment. Typically, the PLCM is derived from a permutation of the bits of the ESN. PLCM may also be based on the Mobile station Equipment Identifier (MEID) or the International Mobile Subscriber Identity (IMSI). The femtocell base station 204 evaluates one or more characteristics of the uplink signal to determine if the wireless communication device transmitting the signal is within the service area of the base station or at least whether the device is possibly within the service area of the detecting base station femtocell base station 204. In the example, the controller 414 determines if the uplink signal 222 can be successfully received. If the signal can be received, the controller 414 determines that the wireless communication device 106 is sufficiently close to receive service from the femtocell base station 204. In some cases, the uplink signal 222 may be detected and received even though the wireless communication device 106 is not within the service area 208 of the femtocell base station 204. In these circumstances, the wireless communication device 106 may unnecessarily be instructed to search for service and will unsuccessfully attempt to acquire service from the femtocell base station 204.

As described above, the femtocell base station 204 intercepts a communication signal 218 transmitted by the wireless communication device 106 to the macrocell base station 202. In response to the detection, the femtocell base station 204 sends the device proximity message 216 to the core network 108 indicating that the wireless communication device 106 is at least possibly within a service area of the femtocell base station 204. The device proximity message 216 may provide any of numerous types of indicators or information based on, determined from, or estimated from the received (intercepted) uplink communication signal 222. The network interface 412 is configured to send the device proximity message 216 to the core network 108. The device proximity message 216 is based on the proximity of the wireless communication device 106 to the femtocell base station 204. Depending on the particular implementation, the device proximity message 216 may be a request to the core network 108 to handoff the wireless communication device 106 to the femtocell base station 204, may indicate the distance between the wireless communication device 106 and the femtocell base station 204, or may indicate the possibility that the wireless communication device 106 may be within range of the femtocell base station 204 to receive wireless service. Examples of information that may be conveyed in the device proximity message 216 include a power level, a signal to noise ratio (SNR), a bit error rate (BER), and/or transmission delay of the uplink communication signal. Therefore, the device proximity message 216 does not necessarily include data that directly indicates proximity of the wireless communication device 106 to the femtocell base station 204. In some circumstances, the femtocell base station may refrain from transmitting the pilot signal 430 until after a wireless communication device 106 is detected. Therefore, the femtocell base station 204 may begin transmitting the pilot signal 430 when the device proximity message 216 is sent to the core network 108.

In response to the device proximity message 216, the core network determines whether the wireless communication device 106 should attempt to acquire service from the femtocell base station 204. The determination may be based on any of numerous factors such as quality of service requirements and capacities of the base stations 202, 204, for example. If the wireless communication device is to attempt to acquire the femtocell base station, a search instruction is transmitted from the macrocell base station to the wireless communication device. An example of a suitable technique of sending an instruction includes sending a control signal 406 that changes the searching scheme, adds the femtocell base station to neighborhood list stored at the wireless communication devices, or otherwise causes the wireless communication device to search for the pilot signals of the femtocell base station or which increases the probability that the pilot signal 430 will be detected.

After the wireless communication device 106 detects the femtocell base station 204 and reports the detection to the macrocell base station 202, the core network 108 invokes a handoff of the wireless communication device 106 from the macrocell base station 202 to the femtocell base station 204. The handoff is in accordance with known techniques except that the wireless communication device remains registered with the macrocell base station 204. Additional information may be provided to the wireless communication devices indicating that the wireless communication device should enter the dual idle-traffic state. In some situations, additional information may not be needed, or may be provided at different times.

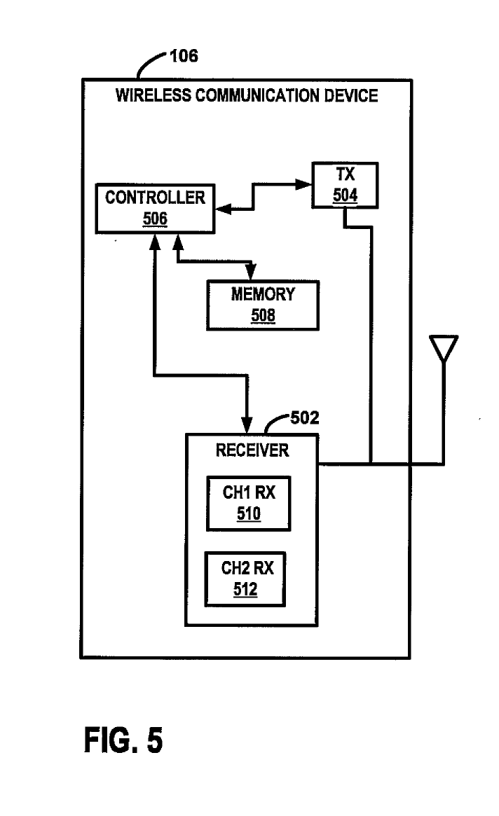

FIG. 5 is a block diagram of a wireless communication device 106. The wireless communication device 106 may be any type of wireless device that can be used for voice, data, and/or multimedia communication. The wireless communication device at least includes a receiver 502 and a transmitter 504 for communicating with the first transceiver node and the second transceiver node. Where the device 106 can also communicate in other types of systems, the device 106 may include additional receivers and transmitters. The various functions and operations of the blocks described with reference to the wireless communication device 106 may be implemented in any number of devices, circuits, or elements. Two or more of the functional blocks may be integrated in a single device and the functions described as performed in any single device may be implemented over several devices. For example, at least portions of the functions of the receiver 502 and transmitter 504 may be performed by the controller 506 in some circumstances.

The wireless communication device 106 includes a controller 506, and a memory 508. The controller 506 is any electronics, processor, microprocessor, or processor arrangement that manages the functions described herein as well as facilitating the overall functionality of the wireless communication device 106. The memory 508 is any combination of RAM and/or ROM devices that can store code, ID values, and other parameters, values, and data for facilitating the described tasks. In some cases, at least a portion of the memory 508 is part of the controller 506.

The receiver 502 is capable of receiving signals from both transceiver nodes 102, 104. Accordingly, the receiver 502 may be a single device that is capable of tuning to multiple channels or may include multiple receivers 510, 512 where each receiver 510, 512 receives signals from a different transceiver node. For the example, a first channel receiver 510 receives signals from the first transceiver node and the second channel receiver 512 receives signals from the second transceiver node 104. The channels may be frequency, code, time, or any combination thereof, depending on the particular communication protocols used in the system 200.

During the traffic state with the macrocell base station 202 (first transceiver node 102), the second channel receiver 512 monitors the appropriate channels for the pilot signals 430 transmitted by the femtocell base station 204 (second transceiver node 104). The search may be in response to a search instruction received from the macrocell base station 202 or may be part of the pilot signal search scheme. The search for pilot signals performed by the wireless communication device 106 may be periodic, continuous, or occasional. Typically, the wireless communication device executes a searching scheme that searches for pilot signals within a neighborhood list which is stored in memory 508 and may be updated at certain times. The wireless communication device records signal strength and/or other parameters related to the quality of the pilot signals that are detected. A pilot signal report is sent to the originating transceiver node.

The first channel receiver 510 receives control signals from the macrocell base station invoking a handoff to the femtocell base station 204. The receiver is configured to receive a handoff control message from the first transceiver node. The controller processes and manages the handoff in response to the handoff control message. During and after the handoff, however, the first channel receiver continues to receive the first control signals 406 from the macrocell base station 202 (first transceiver node 102). The second channel receiver receives control and traffic signals from the femtocell base station 402 (second transceiver node 204).

Therefore, the receiver 502 in the wireless communication device 106 is configured to wirelessly receive the first control signals from a first transceiver node and to wirelessly receive, from the second transceiver node, second control signals 408 which are different from the first control signals. The controller is configured to monitor the first control signals to maintain registration with the first transceiver node while receiving traffic channel signals from the second transceiver node using the second control signals.

In some situations, the first control signals are transmitted from the macrocell base station through one control channel of a dual control channel. The receiver, therefore, is configured to receive the first control signals within one control channel of the dual control channel used by the first transceiver node for transmitting control signals. An example of a suitable dual control channel scheme includes using control channels having different modulation order and using a lower modulation order to send control signals to the wireless communication in the dual idle-traffic state.

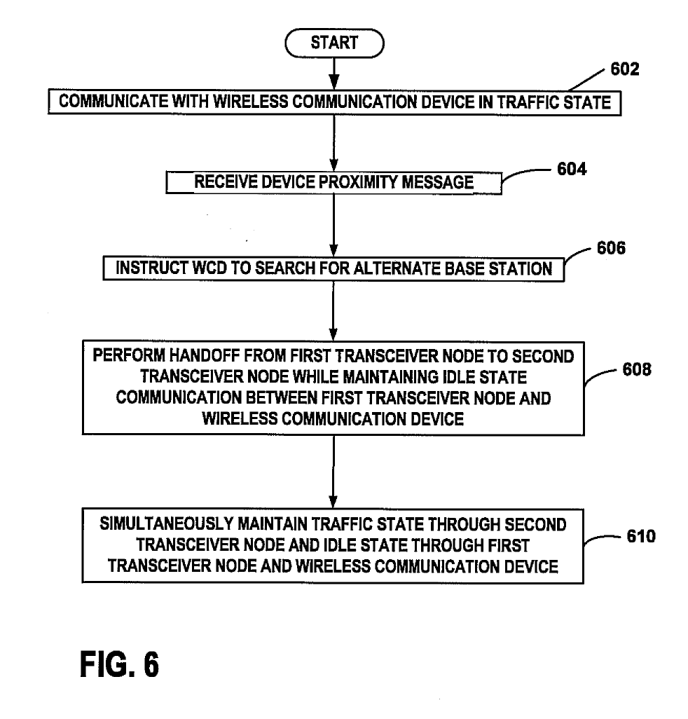

FIG. 6 is a flowchart of a method of managing wireless service to a wireless communication device 106 performed at a core network 108. The method may be performed by any combination of hardware, software, and/or firmware. The order of the steps discussed below may be varied and one or more steps may be performed simultaneously in some circumstances. In the exemplary embodiment, the method is performed, at least in part, by executing code on the controller 410.

At step 602, the core network 108 manages traffic communication with the wireless communication device 106 through the first transceiver node 102. The first transceiver node 102, such as a macrocell base station 202, communicates with the wireless communication device 106 in the traffic state. Accordingly, the first transceiver node 102 exchanges traffic signals 404 and the first control signals 406 with the wireless communication device.

At step 604, a device proximity message 216 is received. The message is received from the second transceiver node 104 through backhaul connecting the core network 108 to the second transceiver node 104. Where the second transceiver node 104 is a femtocell base station 204, the connection may include the IP network 214 and femtocell gateway 210.

At step 606, the wireless communication device 106 is instructed to search for alternate transceiver nodes. An example of suitable instruction includes an update to the neighborhood list stored in the wireless communication device 106 to include the second transceiver node 104. In some circumstances, this step can be omitted. For example, where the neighborhood list already contains date related to the second transceiver node 104 and the second transceiver node 104 begins transmitting the pilot signal 430 after detecting the wireless communication device 106, the wireless communication device 106 will detect the pilot signal 430 without additional instruction.

At step 608, the network manages a handoff from the first transceiver node 102 to the second transceiver node 104 while maintaining idle state communication with the wireless communication device 106 through the first transceiver node 102. Appropriate control signals (handoff control signal) are transmitted to the wireless communication device 106 to process the handoff without terminating registration of the wireless communication device on the first transceiver node.

At step 610, the traffic state of the wireless communication device 106 is maintained with the second transceiver node and the idle state is maintained with the first transceiver node 102. The first transceiver node 102, therefore, continues to send control signals 406 to the wireless communication device 106 in accordance with the idle state protocol. The first transceiver node 102 also receives signals from the wireless communication device 106 to maintain the idle state. For example, changes in device location may be received from the wireless communication device 106 in accordance with idle state protocols. The second transceiver node 104 exchanges traffic signals 428 and the second control signals 408 associated with the traffic state of the wireless communication device 106.

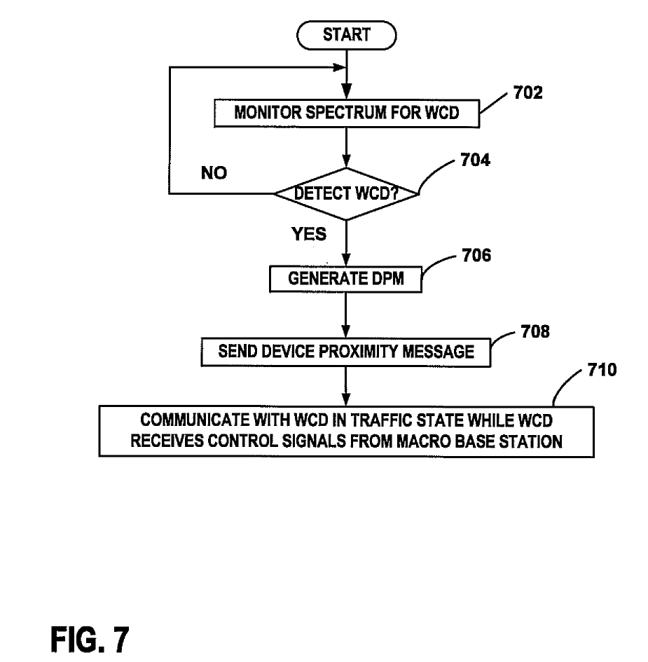

FIG. 7 is a flowchart of a method of managing wireless service to a wireless communication device 106 performed at second transceiver node 104 such as a femtocell base station 204. The method may be performed by any combination of hardware, software, and/or firmware. The order of the steps discussed below may be varied and one or more steps may be performed simultaneously in some circumstances. In the exemplary embodiment, the method is performed, at least in part, by executing code on the controller 414 in the femtocell base station 204.

At step 702, the spectrum is monitored for the detection signal 220. Although the detection may be any of several types of signals, the detection signal is an uplink communication signal in the example. Therefore, where the second transceiver node 104 is a femtocell base station 204, the uplink channel assigned to the macrocell base station 402 is monitored. In the exemplary embodiment, the uplink receiver 402 is tuned to decode any uplink signals 222 transmitted from any communication devices 106 identified in the user list. The uplink scheduling information enables more efficient uplink monitoring. The femtocell base station 404 may detect communication devices that are not in the user list but will not be able to decode the signals without identification information. In some circumstances, however, the uplink receiver 402 may be configured to monitor all uplink channels.

At step 704, it is determined whether a wireless communication device 106 has been detected. Where the detection signal 220 is an uplink signal 222, the controller 414 determines if the uplink receiver 402 has received an uplink signal 222. The controller 414 determines whether an uplink signal has been received from a communication device listed in the user list. If an uplink signal has been received, the method continues at step 706. Otherwise, the method returns to step 702 to continue monitoring the uplink channels.

At step 706, the device proximity message is generated. For the example, the device proximity message is generated if the wireless communication device 106 is detected. In some circumstances, however, the controller 414 may evaluate parameters to determine if the device proximity message should be sent. The proximity of the communication device 106 to the femtocell base station 204 may be calculated and compared to a threshold where the proximity calculation may be based on any number of parameters or characteristics of the received uplink signal 222 as well as other factors. Examples of suitable parameters include parameters related to signal power level and a timing offset between a transmission and reception times. Other related factors may include transmission power level, location of one or more macrocell base stations and information extracted from uplink signals and downlink signals, such as time stamps, power level indicators, and power control indicators. In some circumstances, the proximity is based only on a detection of the uplink signal. The particular factors and calculation techniques depend on the type of communication system 200. The controller may also determine whether the communication device 106 should attempt a handoff to the femtocell. Although the determination may be based solely on the proximity of the communication device 106 to the femtocell base station 204, other factors may be considered in some circumstances. Examples of other factors include the capacity of the femtocell base station 204, the required bandwidth required by the wireless communication device 106, the current cost of the service from the macrocell base station 202 and the estimated motion of the communication device 106. If the controller 414 determines that a handoff should be performed, the device proximity message is generated. In some circumstances, the femtocell base station 204 may send proximity information to the core network 108 with other information to allow the core network 108 to make the determination of whether a communication device 106 should attempt a handoff or attempt a search for the femtocell base station 204. Therefore, the device proximity message at least indicates to the core network 108 that the wireless communication device has been detected. The device proximity message may also include other information, such as proximity information, identification information, and other data useful to the core network 108.

At step 708, a device proximity message 216 is sent to the core network 108. In the example, the message 216 is transmitted by the network interface 412 through the IP network 214 through the access gateway 210 to the core network 108. As discussed above, the device proximity message 216 at least indicates that the communication device 106 may be within range of the femtocell base station 204 although other indications and information may be included. For example, in addition to identifying the wireless communication device 106, the message may identify the femtocell base station 204. The femtocell base station 204 may transmit the message using other techniques. In some circumstances, for example, the message 216 may be transmitted through an uplink channel to the macrocell base station 202. The core network 108 may initiate searching for the specific femtocell base station, initiate searching for any femtocell base station, or may directly initiate a handoff to the femtocell base station 204.

At step 710, the femtocell base station 204 communicates with the wireless communication device 106 in the traffic state while the wireless communication device 106 communicates with the macrocell base station 202 in the idle state. Accordingly, the wireless communication device 106 is in the duel idle-traffic state. The femtocell base station 204 transmits and traffic signals and the second control signals while the macrocell base station transmits the first control signals, different from the second control signals and associated with the idle state.

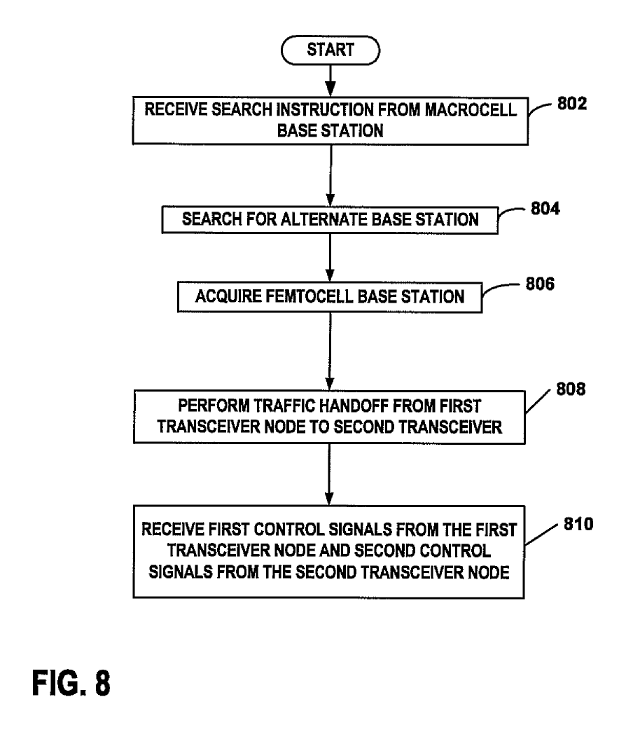

FIG. 8 is a flowchart of a method of managing wireless communication performed at a wireless communication device 106. The method may be performed by any combination of hardware, software, and/or firmware. The order of the steps discussed below may be varied and one or more steps may be performed simultaneously in some circumstances. In the exemplary embodiment, the method is performed, at least in part, by executing code on the controller 506.

At step 802, a search instruction is received from the first transceiver node 102 (macrocell base station 202). As discussed above, the search message may be any update to the neighborhood search list stored in memory 508 that results in an increased likelihood for the wireless communication device to detect the pilot signal 430 transmitted from the second transceiver node 104 (femtocell base station 204). This step can be omitted in some circumstances.

At step 804, the wireless communication device searches for the second transceiver node 102 (femtocell base station 204). The appropriate channels are searched in accordance with the search scheme to look for the pilot signal 430.

At step 806, the second transceiver node 102 (femtocell base station 204) is acquired. The pilot signal 430 is detected and the appropriate access control signals are received and processed by the controller 506.

At step 8081a traffic handoff procedure from the first transceiver node 102 to the second transceiver node 104 is performed while maintaining idle state communication with the first transceiver node 102. Appropriate control signals (handoff control signal) are received from the first transceiver node to process the handoff without terminating registration with the first transceiver node. Accordingly, although the handoff procedure is in accordance with known techniques it is not a conventional handoff since the wireless communication device remains registered and continues operating in an idle state with respect to the first transceiver node 102.

At step 810, the first control signals are received from the first transceiver node and the second control signals are received from the second transceiver node 102. The wireless communication device 106 maintains the traffic state with the second transceiver node and the idle state with the first transceiver node 102. The wireless communication device 106 continues to receive control signals 406 in accordance with the idle state protocol from first transceiver node 102. The wireless communication device may also transmit uplink control signals associated with the idle state to first transceiver node 102 to maintain the idle state. For example, changes in device location may be transmitted from the wireless communication device 106 in accordance with idle state protocols.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A wireless communication device comprising:
a receiver configured to wirelessly receive first control signals from a first transceiver node and to wirelessly receive, from a second transceiver node, second control signals different from the first control signals;
a controller configured to monitor the first control signals to maintain registration with the first transceiver node while receiving traffic channel signals from the second transceiver node using the second control signals.

2. The wireless communication device of claim 1, wherein the receiver is configured to receive the first control signals within one control channel of a dual control channel used by the first transceiver node for transmitting control signals.

3. The wireless communication device of claim 2, wherein a modulation order of the one control channel is lower than another modulation order of another control channel of the dual control channel.

4. The wireless communication device of claim 1, wherein the first transceiver node provides wireless service within a first node service area larger than a second node service area of the second transceiver node.

5. The wireless communication device of claim 1, wherein the receiver is configured to receive a handoff control message from the first transceiver node, the controller configured to process, in response to the handoff control message, a handoff from the second transceiver node to the first transceiver node to invoke reception of traffic channel signals from the first transceiver node.

6. The wireless communication device of claim 1, wherein the controller maintains a wireless communication device in a dual idle-traffic state where the wireless communication device is in an idle state relative to the first transceiver node while the wireless communication device is in a traffic state relative to the second transceiver node.

7. A method comprising:
wirelessly receiving first control signals from a first transceiver node;
wirelessly receiving, from a second transceiver node, second control signals different from the first control signals; and
monitoring the first control signals to maintain registration with the first transceiver node while receiving traffic channel signals from the second transceiver node using the second control signals.

8. The method of claim 7, wherein receiving the first control signals comprises receiving the first control signals within one control channel of a dual control channel used by the first transceiver node for transmitting control signals.

9. The method of claim 8, wherein a modulation order of the one control channel is lower than another modulation order of another control channel of the dual control channel.

10. The method of claim 7, wherein the first transceiver node provides wireless service within a first node service area larger than a second node service area of the second transceiver node.

11. The method of claim 7, further comprising:
receiving a handoff control message from the first transceiver node; and
performing a handoff procedure from the second transceiver node to the first transceiver node in response to the handoff control message to invoke reception of traffic channel signals from the first transceiver node.

12. The method of claim 7, further comprising:
maintaining the wireless communication device in a dual idle-traffic state where the wireless communication device is in an idle state relative to the first transceiver node while the wireless communication device is in a traffic state relative to the second transceiver node.

13. A wireless communication system comprising:
a first transceiver node configured to transmit first control signals to a wireless communication device to maintain registration of the wireless communication device within the first transceiver node;
a second transceiver node configured to transmit traffic signals and to transmit second control signals, different from the first control signals, to the wireless communication device.

14. The wireless communication system of claim 13, wherein the first transceiver node is further configured to transmit signals within at dual control channel and to transmit the first control signals within one control channel of a dual control channel.

15. The wireless communication system of claim 14, wherein a modulation order of the one control channel is lower than another modulation order of another control channel of the dual control channel.

16. The wireless communication system of claim 13, wherein the first transceiver node is configured to provide wireless service within a first node service area and wherein the second transceiver node is configured to provide wireless service within a second node service area smaller than the first node service area.

17. The wireless communication system of claim 13, wherein the first transceiver node is further configured to send a handoff control message to invoke a handoff of the wireless communication device from the second transceiver node to the first transceiver node to invoke reception of traffic channel signals from the first transceiver node.

18. The wireless communication system of claim 13, wherein the first transceiver node is further configured to maintain the wireless communication device in an idles state and the second transceiver node is configured to maintain the wireless communication device in a traffic state while the wireless communication device is in the idle state relative to the first transceiver node.

19. A wireless communication device configured to maintain an idle state relative to a first transceiver node while maintaining a traffic state with a second transceiver node.

20. The wireless communication device of claim 19, wherein the idle state comprises receiving first control signals from the first transceiver node and the traffic state comprises exchanging traffic channel signals with the second transceiver node.
